(19) United States
(12) Patent Application Publication
(10) Pub. No.: US 2025/0382172 A1
(43) Pub. Date: Dec. 18, 2025

(54) DME REFORMING SYSTEM FOR SMART FARM AND POWER PLANT

(71) Applicant: BIO FRIENDS INC., Daejeon (KR)

(72) Inventors: Wonjun CHO, Gyeonggi-do (KR); Wonjae CHO, Seoul (KR); Youngsoo LEE, Chungcheongbuk-do (KR); Jeseol LEE, Daejeon (KR); Hyejin YU, Daejeon (KR); Junwoo LEE, Daejeon (KR); Hyunseung BYUN, Daejeon (KR); Yeongjun JU, Daejeon (KR); Jeongil LEE, Gyeonggi-do (KR)

(21) Appl. No.: 18/839,940

(22) PCT Filed: Jun. 27, 2022
(86) PCT No.: PCT/KR2022/009135

§ 371 Date: Feb. 7, 2025

(30) Foreign Application Priority Data
Mar. 8, 2022 (KR) 10-2022-0029048

(51) Int. Cl. C01B 3/38; B01D 53/047; H01M 8/0612

(52) U.S. Cl. CPC C01B 3/38; B01D 53/047; H01M 8/0618; C01B 2203/0405; C01B 2203/042; C01B 2203/0475; C01B 2203/066; C01B 2203/085; C01B 2203/146

(57) ABSTRACT

The present invention relates to a dimethyl ether (DME) reforming system for a smart farm and power plant, and the purpose of the present invention is to provide a DME reforming system for a smart farm and power plant, which generates carbon dioxide and hydrogen using DME as a raw material, and supplies a fertilizer and electric energy to a smart farm, and which minimizes the generation of environmental pollutants, in particular, the generation of CO₂ in a DME reforming process.

### TECHNICAL FIELD

The present application claims the benefit of priority based on Korean Patent Application 10-2022-0029048 filed on Mar. 8, 2022, and all contents disclosed in the document of the Korean patent application are included as part of this specification.

The present disclosure relates to a dimethyl ether (DME) reforming system for a smart farm and a power plant, and relates to the DME reforming system for the smart farm and the power plant for producing hydrogen from DME as a raw material and minimizing generation of environmental pollutant, particularly CO₂, in a DME reforming process.

### BACKGROUND ART

Development of eco-friendly energy sources is now a global trend and many countries are working on mid- and long-term plans for new energy technology development. Specifically, focus is made on eco-friendly system development such as new energy technology development system technology improvement, emission control technology improvement, and clean energy conversion.

Among them, a technology which utilizes and converts natural gas which is a clean energy, into other energy source is highly evaluated as a potential for the new fuel energy development, one of which is dimethyl ether (DME) manufactured from various raw materials (natural gas, landfill gas, biogas, biomass, coal, etc.).

The DME manufactured from various raw materials has been spotlighted recently as a transportation energy (fuel), and is attracting attention as an important next-generation fuel with characteristics for compensating for most of physical and chemical shortcomings of natural gas as the fuel.

The DME is the eco-friendly energy source, which may be used in an area or an institution sensitive to environmental issues, such as a hospital and a farm. The DME may be utilized as an energy source in various manners. For example, it may be directly burned and converted into energy, or it may be converted into other form and used as an energy source.

The DME may be applied to a smart farm, to thus supply energy required for farm operation as the eco-friendly energy. In this case, it is necessary to exclude the pollutant generation in the energy conversion process of the DME as much as possible, and to develop an available technology with high efficiency.

### DISCLOSURE OF THE INVENTION

### Technical Goals

The present disclosure relates to a DME reforming system for a smart farm and a power plant, and is to provide the DME reforming system for the smart farm and the power plant for producing hydrogen from dimethyl ether (DME) as a raw material and minimizing generation of environmental pollutant, particularly CO₂, in a DME reforming process.

Technical objects to be achieved by the present disclosure are not limited to the technical objects mentioned above, and other technical objects not mentioned may be clearly understood by those skilled in the art to which the present disclosure pertains from the following description.

### Technical Solutions

A dimethyl ether (DME) reforming system for a smart farm and a power plant of the present disclosure may include,
a DME reforming unit for producing hydrogen and carbon dioxide by reforming DME;
a DME supply unit for supplying DME to the DME reforming unit;
a water supply unit for supplying water to the DME reforming unit;
a fuel cell unit connected to a hydrogen output line of the DME reforming unit;
a carbon dioxide purification unit connected to a carbon dioxide output line of the DME reforming unit;
a carbon dioxide storage unit for storing the carbon dioxide outputted from the carbon dioxide purification unit; and
a power supply unit for supplying electrical power to an electric heater provided in the DME reforming unit.

### Advantageous Effects

The present disclosure relates to a dimethyl ether (DME) reforming system for a smart farm and a power plant, and relates to the DME reforming system for the smart farm and the power plant for producing hydrogen from DME as a raw material and minimizing generation of environmental pollutant, particularly CO₂, in a DME reforming process.

The DME reforming system for the smart farm and the power plant of the present disclosure may produce carbon dioxide and hydrogen using DME as raw material to thus supply fertilizer and electrical energy to the smart farm, and to minimize generation of environmental pollutant, particularly CO₂ in the DME reforming process.

The DME reforming system for the smart farm and the power plant of the present disclosure may minimize the pollutant generation, by supplying the energy in the form of hydrogen.

The DME reforming system for the smart farm and the power plant of the present disclosure may minimize the pollutant generation caused by a heat source, by using a device powered by eco-friendly energy as the heat source in hydrogen production.

The DME reforming system for the smart farm and the power plant of the present disclosure may effectively separate hydrogen and carbon dioxide, and thus maximize utilization of each resource.

### BRIEF DESCRIPTION OF DRAWINGS

FIG. 1 is a block diagram showing a DME reforming system for a smart farm and a power plant of the present disclosure.

FIG. 2 is a block diagram showing a DME reforming unit.

FIG. 3 is a cross-sectional view showing a reactor.

FIG. 4 is a cross-sectional view showing a cross section A-A of FIG. 3.

FIG. 5 is a cross-sectional view showing that a first heating means and a second heating means are disposed in the reactor.

FIG. 6 is a cross-sectional view showing a cross section B-B of FIG. 5.

FIG. 7 is a cross-sectional view showing that a cover means is coupled with the reactor.

FIG. 8 is a cross-sectional view showing that the cover means is separated.

### BEST MODE FOR CARRYING OUT THE INVENTION

A dimethyl ether (DME) reforming system for a smart farm and a power plant of the present disclosure may include,
a DME reforming unit for producing hydrogen and carbon dioxide by reforming DME;
a DME supply unit for supplying DME to the DME reforming unit;
a water supply unit for supplying water to the DME reforming unit;
a fuel cell unit connected to a hydrogen output line of the DME reforming unit;
a carbon dioxide purification unit connected to a carbon dioxide output line of the DME reforming unit;
a carbon dioxide storage unit for storing carbon dioxide outputted from the carbon dioxide purification unit; and
a power supply unit for supplying electrical power to an electric heater provided in the DME reforming unit.

In the DME reforming system for the smart farm and the power plant of the present disclosure, the DME modifying unit may include a mixed gas generator for receiving and mixing the DME and the water from the DME supply unit and the water supply unit respectively to generate a mixed gas; a preheater for receiving from the mixed gas generator and heating the mixed gas; a reactor for preparing a catalyst therein and receiving the mixed gas from the preheater to produce hydrogen and carbon dioxide through a reforming reaction; the electric heater for supplying heat to the reactor; and a separator for receiving the hydrogen and the carbon dioxide in a mixed state from the reactor and separating them from each other to discharge the hydrogen and the carbon dioxide to the hydrogen output line and the carbon dioxide output line, respectively.

In the DME reforming system for the smart farm and the power plant of the present disclosure, the reactor may include a reaction tube formed in a cylindrical shape and having the catalyst therein, a heating means insertion tube formed along a central axis of the reaction tube, an inlet positioned at one end of the reaction tube and being injected with the mixed gas, and an outlet positioned at the other end of the reaction tube and discharging hydrogen and carbon dioxide.

In the DME reforming system for the smart farm and the power plant of the present disclosure, the electric heater may include a first heating means inserted into the heating means insertion tube, a plurality of second heating means positioned along an outer peripheral surface of the reaction tube, and a cover means for covering the outer peripheral surface of the reaction tube with the plurality of secondary heating means interposed therebetween.

In the DME reforming system for the smart farm and the power plant of the present disclosure, the first heating means and the plurality of second heating means may be infrared (IR) heaters.

In the DME reforming system for the smart farm and the power plant of the present disclosure, the power supply unit may include at least one or more of a wind power system, a hydroelectric power system, a tidal power system, a wave power system, a photovoltaic system, and a geothermal power system.

In the DME reforming system for the smart farm and the power plant of the present disclosure, the carbon dioxide purification unit may include, a first purifier connected with the carbon dioxide output line and purifying carbon dioxide from a gas delivered through the carbon dioxide output line; and a second purifier for receiving the purified gas from the first purifier and purifying carbon dioxide once more.

In the DME reforming system for the smart farm and the power plant of the present disclosure, the first purifier may be equipped with a membrane for separating carbon dioxide and hydrogen, and the second purifier may be equipped with an adsorbent for adsorbing carbon dioxide.

In the DME reforming system for the smart farm and the power plant of the present disclosure, the second purifier may purify carbon dioxide through a pressure swing adsorption (PSA) method.

In the DME reforming system for the smart farm and the power plant of the present disclosure, the carbon dioxide purification unit may further include, a first hydrogen recovery flow path for delivering hydrogen separated at the first purifier to the hydrogen output line; and a second hydrogen recovery flow path for delivering hydrogen separated at the second purifier to the hydrogen output line.

### MODES FOR CARRYING OUT THE INVENTION

Hereinafter, embodiments according to the present disclosure will be described in detail with reference to the accompanying drawings. In so doing, a size or a shape of components shown in the drawings may be exaggerated for clarity and convenience of explanation. In addition, terms specifically defined in consideration of configuration and operation of the present disclosure may vary depending on intention or practice of a user or an operator. Definitions of these terms should be made based on the content throughout this specification.

In the description of the present disclosure, it should be noted that an orientation or position relationship indicated by a term such as “center”, “top”, “bottom”, “left”, “right”, “vertical”, “horizontal”, “inside”, “outside”, “one side”, and “the other side” is based on an orientation or position relationship indicated in the drawings, or an orientation or position relationship normally placed when using a product of the present disclosure, is only for explanation and brief explanation of the present disclosure, and does not suggest or imply that a device or an element displayed should have a specific orientation or be configured or operated in a specific orientation, which should not be construed as limiting the present disclosure.

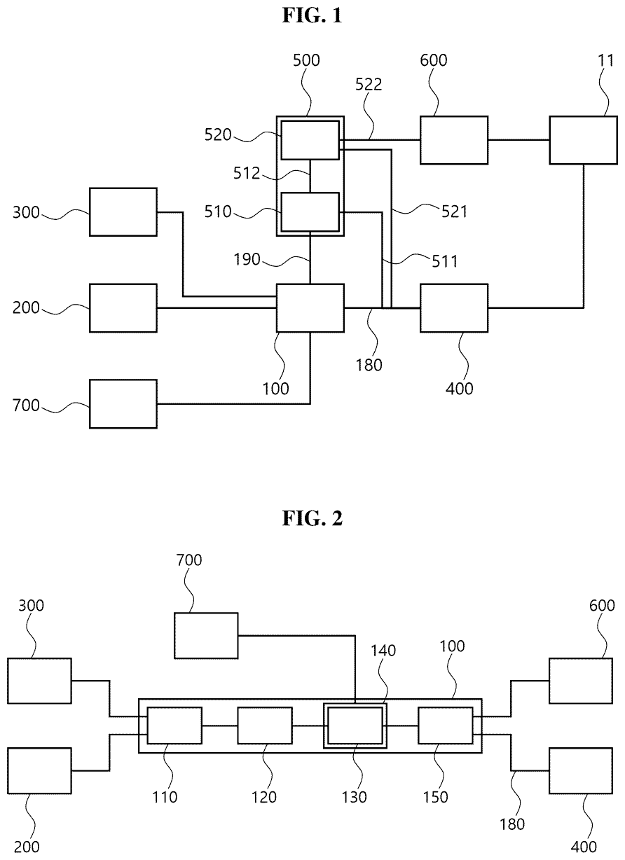

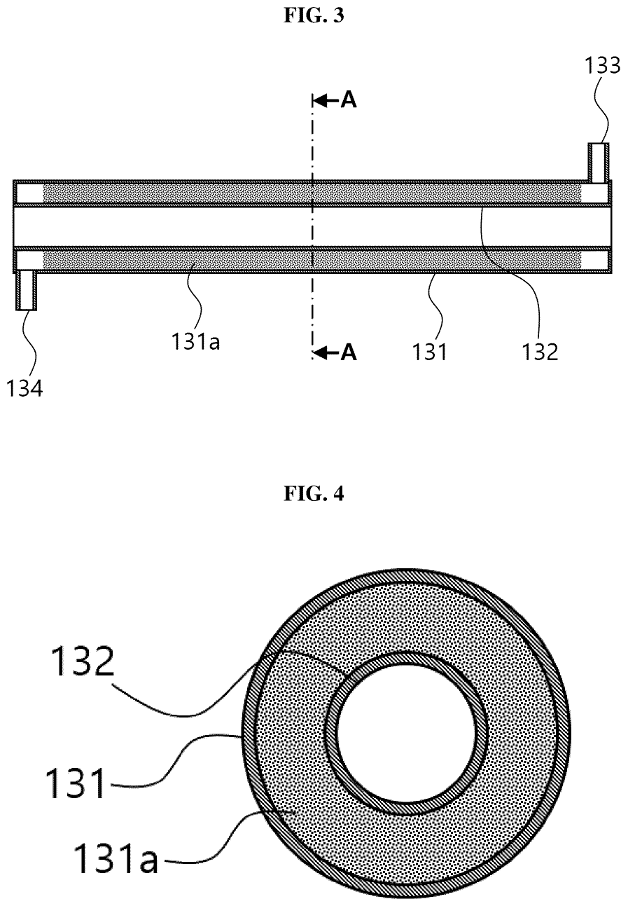

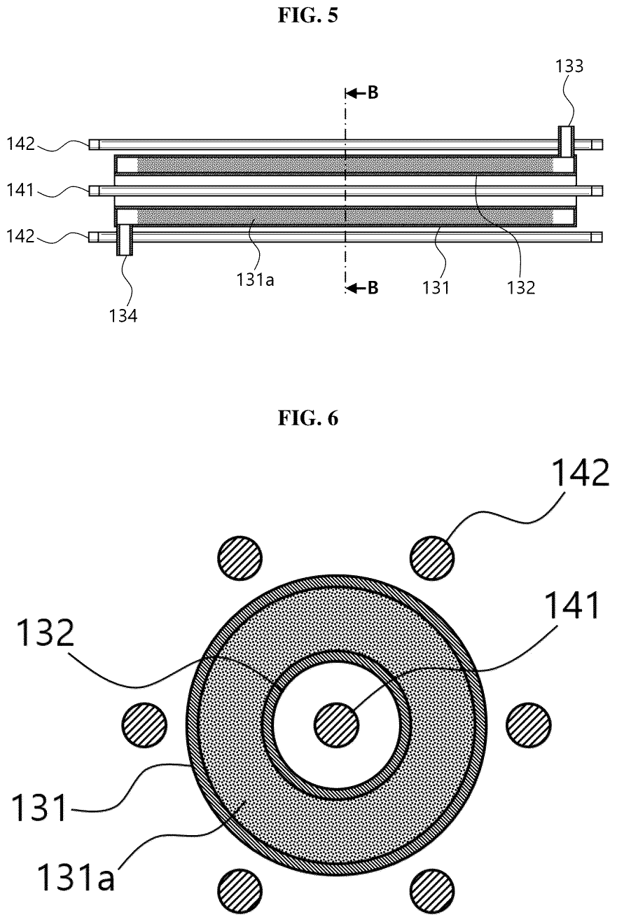

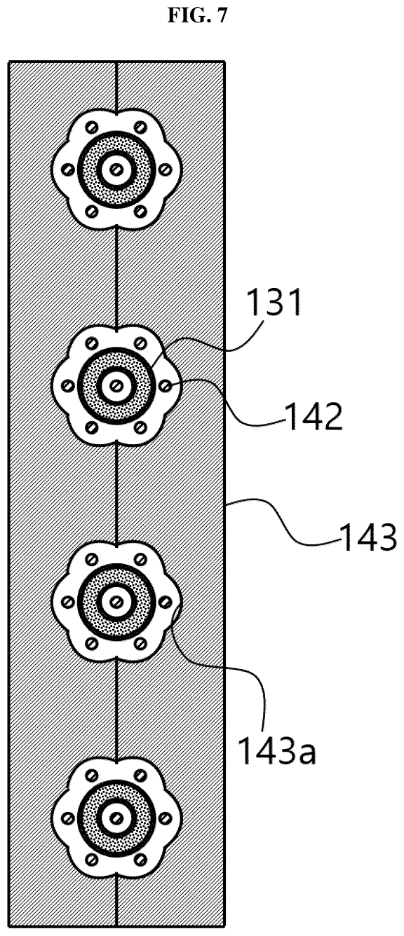

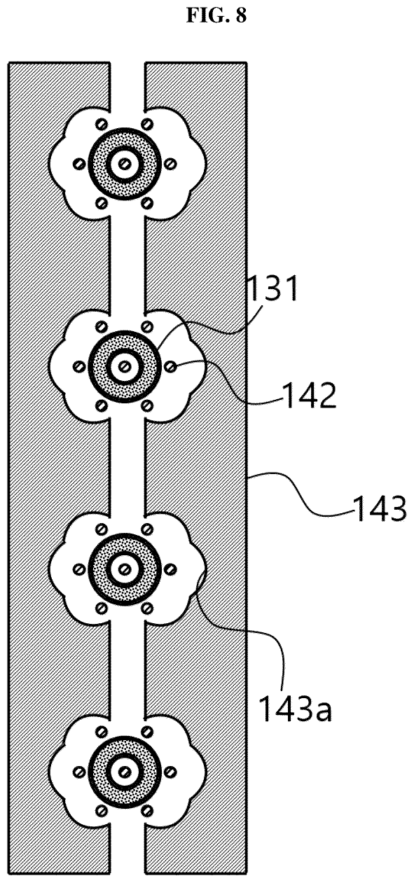

FIG. 1 is a block diagram showing a DME reforming system for a smart farm and a power plant of the present disclosure. FIG. 2 is a block diagram showing a DME reforming unit 100. FIG. 3 is a cross-sectional view showing a reactor 130. FIG. 4 is a cross-sectional view showing a cross section A-A of FIG. 3. FIG. 5 is a cross-sectional view showing a first heating means 141 and a second heating means 142 disposed in the reactor 130. FIG. 6 is a cross-sectional view showing a cross section B-B of FIG. 5. FIG. 7 is a cross-sectional view showing that a cover means 143 is coupled with the reactor 130. FIG. 8 is a cross-sectional view showing that the cover means 143 is separated.

Hereinafter, referring to FIG. 1 through FIG. 8, the DME reforming system for the smart farm and the power plant of the present disclosure will be described in detail.

The DME reforming system for the smart farm and the power plant of the present disclosure may produce carbon dioxide and hydrogen using dimethyl ether (DME) as raw material to thus supply fertilizer and electrical energy to the smart farm, and minimize generation of an environmental pollutant, particularly CO₂ in the DME reforming process.

The DME reforming system for the smart farm and the power plant of the present disclosure may fertilize and supply power using the DME as a raw material without generating a pollutant to a smart farm 11 which is sensitive to generation and access of the environmental pollutant.

The DME reforming system for the smart farm and the power plant of the present disclosure is to reform the DME, and specifically, is to produce hydrogen and carbon dioxide through DME steam reforming. The DME steam reforming may produce hydrogen at an even lower temperature than methane steam reforming.

The DME steam reforming may first generate methanol (CH₃OH) through hydrolysis reaction of DME, and then separate the generated methanol into CO₂ and H₂ through steam reforming reaction. In addition, hydrogen may be additionally produced by Water Gas Shift Reaction (WGSR) which converts the remaining CO and steam in the generated product into CO₂ and H₂ at a carbon monoxide conversion reactor.

As shown in FIG. 1, the DME reforming system for the smart farm and the power plant of the present disclosure may include,
a DME reforming unit 100 for producing hydrogen and carbon dioxide by reforming DME;
a DME supply unit 200 for supplying DME to the DME reforming unit 100;
a water supply unit 300 for supplying water to the DME reforming unit 100;
a fuel cell unit 100 connected to a hydrogen output line 180 of the DME reforming unit 180;
a carbon dioxide purification unit 500 connected to a carbon dioxide output line 190 of the DME reforming unit 100;
a carbon dioxide storage unit 600 for storing carbon dioxide outputted from the carbon dioxide purification unit 500; and
a power supply unit 700 for supplying electrical power to an electric heater 140 provided in the DME reforming unit 140.

As shown in FIG. 2, the DME reforming unit 100 may include, a mixture gas generator 110 for producing mixed gas by receiving and mixing DME and water from the DME supply unit 200 and the water supply unit 300 respectively; a preheater 120 for receiving and heating the mixed gas from the mixed gas generator 110; a reactor 130 for preparing a catalyst 131a therein, receiving the mixed gas from the preheater 120 and producing hydrogen and carbon dioxide through a reforming reaction; an electric heater 140 for supplying heat to the reactor 130; and a separator 150 for receiving the hydrogen and the carbon dioxide in a mixed state from the reactor 130 and separating them from each other to discharge the hydrogen and the carbon dioxide to the hydrogen output line 180 and the carbon dioxide output line 190, respectively.

The mixed gas generator 110 may generate the mixed gas in the gaseous state by mixing the water and the DME and then transfer to the preheater 120. The mixed gas generator 110 may be provided with a heat source to make the water and the DME gaseous.

The preheater 120 may preheat the mixed gas injected into the reactor 130 by exchanging heat with a flow path which delivers the product produced in the reactor 130 to the separator 150. In other words, the preheater 120 may be used for the heat exchange between an input flow path which injects the mixed gas into the reactor 130 and an output flow path which discharges the product produced in the reactor 130.

As shown in FIG. 3 and FIG. 4, the reactor 130 may include, a reaction tube 131 formed in a cylindrical shape and provided with the catalyst 131a therein, a heating means insertion tube 132 formed along a central axis of the reaction tube 131, an inlet 133 positioned at one end of the reaction tube 131 and receiving the mixed gas injected, and an outlet 134 positioned at the other end of the reaction tube 131 and discharging the hydrogen and the carbon dioxide.

The reaction tube 131 may be provided in the cylindrical shape extending in one direction. Since the cylindrical heating means insertion tube 132 extending in a longitudinal direction of the reaction tube 131 is positioned in the center of the reaction tube 131, a space in which the catalyst 131a is positioned in the reaction tube 131 and the DME is reformed may be formed in a ring shape, as shown in FIG. 4, on a cross section perpendicular to the longitudinal direction of the reaction tube 131.

As shown in FIG. 3, the inlet 133 and the outlet 134 may be positioned at the two ends of the reaction tube 131 respectively. Hence, the mixed gas of water vapor and the DME injected into the reaction tube 131 may flow along the longitudinal direction of the reaction tube 131.

As shown in FIG. 3, an area filled with the catalyst 131a inside the reaction tube 131 may be formed by excluding a certain space at both ends of the reaction tube 131. The inlet 133 and outlet 134 may be positioned in an area not filled with the catalyst 131a on the reaction tube 131. Thus, the mixed gas injected into the reaction tube 131 may be converted into a ring shape on the cross-section perpendicular to the longitudinal direction of the reaction tube 131, and then flow along the longitudinal direction of the reaction tube 131.

A plurality of the reactors 130 may be provided, and the plurality of reactors 130 may be coupled in series, with the inlet 133 and the outlet 134 connected to each other.

As shown in FIG. 5 and FIG. 6, the electric heater 140 may include, a first heating means 141 inserted into the heating means insertion tube 132, a plurality of second heating means 142 positioned along an outer peripheral surface of the reaction tube 131, and a cover means 143 for covering the outer peripheral surface of the reaction tube 131 with the plurality of second heating means 142 interposed therebetween.

As shown in FIG. 5, the first heating means 141 and the second heating means 142 may be arranged in a rod shape extending in the longitudinal direction of the reaction tube 131. The first heating means 141 and the second heating means 142 may be formed longer than a length of the reaction tube 131. Therefore, the two ends of the first heating means 141 and the second heating means 142 may protrude further than the two ends of the reaction tube 131.

As shown in FIG. 6, on the cross-section perpendicular to the longitudinal direction of the reaction tube 131, the first heating vehicle 141 may be positioned in the center of the reaction tube 131. In other words, the central axis of the reaction tube 131 and the central axis of the first heating means 141 may coincide with each other.

As shown in FIG. 6, the plurality of second heating means 142 may be provided. On the cross section perpendicular to the longitudinal direction of reaction tube 131, the plurality of second heating means 142 may be positioned outside the circle formed by the reaction tube 131, and arranged at equal intervals along a circumference of the circle formed by the reaction tube 131.

As shown in FIG. 7, the cover means 143 may cover the outer peripheral surface of the reaction tube 131 with the plurality of second heating means 142 interposed therebetween. The cover means 143 may have a recess 143a formed at a position facing the second heating means 142. Therefore, a plurality of recesses 143a may be provided for the second heating means 142 provided in plural. The recess 143a may be formed as a long groove extending along the longitudinal direction of the reaction tube 131, and may be formed as a curved surface on the cross-section perpendicular to the longitudinal direction of the reaction tube 131.

As shown in FIG. 8, the cover means 143 may include two cover members, and each cover member may be coupled to cover both sides of the reaction tube 131.

The first heating means 141 and the plurality of second heating means 142 may be IR heaters. The DME reforming system for the smart farm and the power plant of the present disclosure may exclude pollutant generation caused by the heater, by using the IR heater which uses cell energy as the heat source for supplying the heat to the reactor 130. For example, heaters for supplying heat from combustion of commonly used fuels may generate a pollutant, and the pollutant may adversely affect the environment such as a farm. By using the IR heater which uses the cell energy as the heat source to supply the heat to the reactor 130, the DME reforming system for the smart farm and the power plant of the present disclosure may exclude the adverse effect of emitting an environmental pollutant in an eco-friendly space.

The separator 150 may separate hydrogen and carbon dioxide through gas liquid separation and thus discharge the hydrogen and the carbon dioxide to the hydrogen output line 180 and carbon dioxide output line 190, respectively.

The power supply unit 700 may include at least one or more of a wind power system, a hydroelectric power system, a tidal power system, a wave power system, a photovoltaic system, and a geothermal power system. The power supply unit 700 may be selected from renewable energy systems which do not generate an environmental pollutant.

The carbon dioxide purification unit 500 may include a first purifier 510 connected to the carbon dioxide output line 190 and purifying carbon dioxide from a gas delivered through the carbon dioxide output line 190; and a second purifier 520 for receiving the purified gas from the first purifier 510 and purifying carbon dioxide once more. In other words, the first purifier 510 and the second purifier 520 may be connected in series. In the DME reforming system for the smart farm and the power plant of the present disclosure, the carbon dioxide purification unit 500 may enable to obtain high-purity hydrogen and carbon dioxide by re-separating the hydrogen in various manners with respect to purified carbon dioxide.

The first purifier 510 may be provided with a membrane for separating the carbon dioxide and the hydrogen, and the second purifier 520 may be provided with an adsorbent for adsorbing the carbon dioxide.

In the first purifier 510, the membrane may purify the hydrogen through membrane separation.

The second purifier 520 may purify the carbon dioxide using a pressure swing adsorption (PSA) method. The second purifier 520 may adsorb carbon dioxide to an adsorbent to separate it from the hydrogen once more, and then collect it separately by separating the carbon dioxide to the adsorbent through pressure fluctuations.

The carbon dioxide purification unit 500 may further include a first hydrogen recovery flow path 511 for delivering the hydrogen separated at the first purifier 510 to the hydrogen output line 180; and a second hydrogen recovery flow path 521 for delivering the hydrogen separated at the second purifier 520 to the hydrogen output line 180.

The first hydrogen recovery flow path 511 and the first carbon dioxide delivery flow path 512 may be provided as the output line of the first purifier 510, and the second hydrogen recovery flow path 521 and the second carbon dioxide delivery flow path 522 may be provided as the output line of the second purifier 520. The first hydrogen recovery flow path 511 and the second hydrogen recovery flow path 521 may be connected to the hydrogen output line 180, the first carbon dioxide delivery flow path 512 may be connected to the second purifier 520, and the second carbon dioxide delivery flow path 522 may be connected to the carbon dioxide storage unit 600.

The DME supply unit 200 and the water supply unit 300 each may be provided with a pump, to supply the DME and water to the DME reforming unit 100.

The fuel cell unit 400 generates electrical energy by electrochemically reacting a fuel and an oxidizing agent, and may include a fuel cell which uses hydrogen as a fuel and oxygen as an oxidizing agent. The fuel cell unit 400 may be connected to the hydrogen output line 180 of the DME reforming unit 100, and supply the generated electricity to the smart farm 11.

The carbon dioxide storage unit 600 may be a storage tank for storing the carbon dioxide received from the carbon dioxide purification unit. The carbon dioxide stored in the carbon dioxide storage unit 600 may be supplied to the smart farm 11.

In other words, the DME reforming system for the smart farm and the power plant of the present disclosure utilizes both the hydrogen and the carbon dioxide generated through the DME steam reforming, and specifically, may generate the electrical energy from the hydrogen to supply the electrical energy required for the operation of the smart farm 11, and help crop growth using the carbon dioxide.

The embodiments of the present disclosure have been described above, but they are only illustrative, and those skilled in the art will understand that various modifications and equivalents of embodiments are possible therefrom. Accordingly, the true scope of technical protection of the present disclosure should be determined by the following patent claims:

### EXPLANATION OF SYMBOLS

11 . . . Smart farm 100 . . . DME reforming unit
110 . . . Mixed gas generator 120 . . . Preheater
130 . . . Reactor 131 . . . Reaction tube
131a . . . Catalyst 132 . . . Heating means insertion tube
133 . . . Inlet 134 . . . Outlet
140 . . . Electric heater 141 . . . First heating means
142 . . . Second heating means 143 . . . Cover means
143a . . . Recess 150 . . . Separator
180 . . . Hydrogen output line 190 . . . Carbon dioxide output line
200 . . . DME supply unit 300 . . . Water supply unit
400 . . . Fuel cell unit 500 . . . Carbon dioxide purification unit
510 . . . First purifier 511 . . . First hydrogen recovery flow path
512 . . . First carbon dioxide delivery flow path 520 . . . Second purifier
521 . . . Second hydrogen recovery flow path 522 . . . Second carbon dioxide delivery flow path
600 . . . Carbon dioxide storage unit 700 . . . Power supply unit

### INDUSTRIAL APPLICABILITY

The present disclosure relates to a dimethyl ether (DME) reforming system for a smart farm and a power plant, and relates to the DME reforming system for the smart farm and the power plant for producing hydrogen from DME as a raw material and minimizing generation of an environmental pollutant, particularly CO₂, in a DME reforming process.

The DME reforming system for the smart farm and the power plant of the present disclosure may produce carbon dioxide and hydrogen using DME as raw material to supply fertilizer and electrical energy to the smart farm, and minimize generation of an environmental pollutant, particularly CO₂ in the DME reforming process.

The DME reforming system for the smart farm and the power plant of the present disclosure may minimize the pollutant generation, by supplying the energy in the form of the hydrogen.

The DME reforming system for the smart farm and the power plant of the present disclosure may minimize the pollutant generation caused by a heat source, by using a device powered by eco-friendly energy as the heat source in the hydrogen production.

The DME reforming system for the smart farm and the power plant of the present disclosure may effectively separate hydrogen and carbon dioxide, and thus maximize utilization of each resource.

1. A dimethyl ether (DME) reforming system for a smart farm and a power plant comprising:
a DME reforming unit that produces hydrogen and carbon dioxide by reforming DME;
a DME supply unit that supplies DME to the DME reforming unit;
a water supply unit that supplies water to the DME reforming unit;
a fuel cell unit connected to a hydrogen output line of the DME reforming unit;
a carbon dioxide purification unit connected to a carbon dioxide output line of the DME reforming unit;
a carbon dioxide storage unit that stores carbon dioxide emitted from the carbon dioxide purification unit; and
a power supply unit that supplies electrical power to an electric heater provided in the DME reforming unit.

2. The DME reforming system for the smart farm and the power plant of claim 1, wherein the DME modifying unit comprises:
a mixed gas generator that receives DME and water from the DME supply unit and the water supply unit, respectively, and mixes DME and water to generate a mixed gas;
a preheater that heats the mixed gas supplied from the mixed gas generator;
a reactor that has a catalyst inside and produces hydrogen and carbon dioxide through a reforming reaction with the mixed gas supplied from the preheater;
an electric heater that supplies heat to the reactor; and
a separator that separates the mixture of hydrogen and carbon dioxide supplied from the reactor and discharge them through a hydrogen output line and a carbon dioxide output line, respectively.

3. The DME reforming system for the smart farm and the power plant of claim 2, wherein the reactor comprises:
a reaction tube formed in a cylindrical shape and having the catalyst therein;
a heating means insertion tube formed along a central axis of the reaction tube;
an inlet positioned at one end of the reaction tube and being injected with the mixed gas; and
an outlet positioned at the other end of the reaction tube and discharging hydrogen and carbon dioxide.

4. The DME reforming system for the smart farm and the power plant of claim 3, wherein the electric heater comprises:
a first heating means inserted into the heating means insertion tube;
a plurality of second heating means positioned along an outer peripheral surface of the reaction tube; and
a cover means for covering the outer peripheral surface of the reaction tube with the plurality of secondary heating means interposed therebetween.

5. The DME reforming system for the smart farm and the power plant of claim 4, wherein the first heating means and the plurality of second heating means are infrared (IR) heaters.

6. The DME reforming system for the smart farm and the power plant of claim 1, wherein the power supply unit comprises at least one or more of a wind power system, a hydroelectric power system, a tidal power system, a wave power system, a photovoltaic system, and a geothermal power system.

7. The DME reforming system for the smart farm and the power plant of claim 1, wherein the carbon dioxide purification unit comprises:
a first purifier connected with the carbon dioxide output line and purifying carbon dioxide from a gas delivered through the carbon dioxide output line; and
a second purifier for receiving the purified gas from the first purifier and purifying carbon dioxide once more.

8. The DME reforming system for the smart farm and the power plant of claim 7, wherein the first purifier is equipped with a membrane for separating carbon dioxide and hydrogen, and
the second purifier is equipped with an adsorbent for adsorbing carbon dioxide.

9. The DME reforming system for the smart farm and the power plant of claim 8, wherein the second purifier purifies carbon dioxide through a pressure swing adsorption (PSA).

10. The DME reforming system for the smart farm and the power plant of claim 8, wherein the carbon dioxide purification unit further comprises:
a first hydrogen recovery flow path for delivering hydrogen separated at the first purifier to the hydrogen output line; and
a second hydrogen recovery flow path for delivering hydrogen separated at the second purifier to the hydrogen output line.
